(19) United States
(12) Patent Application Publication
(10) Pub. No.: US 2025/0190003 A1
(43) Pub. Date: Jun. 12, 2025

(54) LINEAR VOLTAGE REGULATOR

(71) Applicant: STMicroelectronics International N.V., Geneva (CH)

(72) Inventor: Stephan DREBINGER, Munich (DE)

(73) Assignee: STMicroelectronics International N.V., Geneva (CH)

(21) Appl. No.: 18/968,768

(22) Filed: Dec. 4, 2024

(30) Foreign Application Priority Data
Dec. 7, 2023 (IT) 102023000026220

(51) Int. Cl. G05F 1/575

(52) U.S. Cl. CPC G05F 1/575

(57) ABSTRACT

A linear voltage regulator includes a first amplification stage configured to produce an error signal at an intermediate node as a function of a difference between a first reference voltage and a regulated output voltage. An intermediate amplification stage amplifies the error signal to produce an amplified error signal. A driver stage produces a drive signal as a function of the amplified error signal. A pass device is controlled by the drive signal to produce the regulated output voltage. A feedback circuit produces a feedback current as a function of a difference between the drive signal and a second reference voltage. The feedback current is the sourced to the intermediate node.

### PRIORITY CLAIM

This application claims the priority benefit of Italian Application for Patent No. 102023000026220 filed on Dec. 7, 2023, the content of which is hereby incorporated by reference in its entirety to the maximum extent allowable by law.

### TECHNICAL FIELD

The description relates to linear voltage regulators and, in particular, to low-dropout (LDO) voltage regulators.

Low-dropout regulators may be applied to any kind of electronic device, in particular to consumer products such as smart phones and the like, but also to automotive products and industrial products, as well as to the health industry and to Internet-of-Things (IoT) applications.

### BACKGROUND

Low-dropout voltage regulators are a class of DC linear voltage regulators that can operate when the input supply voltage is very close to the regulated output voltage, and are well known in the art as evidenced by: United States Patent Publication Nos. 2023/0123393 A1, 2019/0258282 A1, and 2017/0115678 A1, all incorporated herein by reference and which disclose various architectures of LDO regulators.

Achieving stability of an LDO regulator over a wide range of operating conditions (e.g., different output capacitance COUT, different load current ILOAD, different input voltage VIN and/or different output voltage VOUT) is a design issue. It is known in the art, in order to improve stability of an LDO regulator, to implement a Miller compensation architecture. United States Patent Application Publication Nos. 2014/0125300 A1 and 2009/0128104 A1, both incorporated herein by reference, are exemplary of such Miller-compensated LDO regulators (MC-LDO). Reference is also made to Cremoux, et al., “A new method for multiplying the Miller capacitance using active components,” Proceedings of the IEEE 2003 Custom Integrated Circuits Conference, San Jose, CA, USA, 2003, pp. 697-700, doi: 10.1109/CICC.2003.1249489 (incorporated by reference) which discloses an MC-LDO regulator. Substantially, Miller-compensated LDO regulators include a capacitor arranged between the output of the regulator itself and the output of the error amplifier that controls the pass element of the regulator. In order to fulfill the phase margin (PM) requirements, and thus provide the desired stability, a trade-off between the size of the compensation network, the quiescent current, and the minimum output capacitance has to be taken into account.

U.S. Pat. No. 10,001,795 B2, incorporated herein by reference, discloses a Miller-compensated LDO regulator as well. The LDO regulator includes a first amplification stage, an intermediate amplification stage, a driver stage, and a pass device. A load is coupled with the regulator output in parallel with an output capacitance. The load draws a load current from the regulator. The first amplification stage is a differential amplifier with one input coupled to a reference voltage and the other input coupled to the regulator output voltage, via a voltage divider. The intermediate amplification stage may be an inverter and may include a plurality of substages. The driver stage includes a common source NMOS transistor and a driver transistor that is a PMOS transistor in diode configuration. The gate of the driver transistor is connected with the gate of the pass device which is also a PMOS transistor, both transistors forming a current mirror. A Miller capacitance is coupled between the regulator output terminal and the node between the first amplification stage and the intermediate amplification stage. In order to increase the phase margin at the gain-bandwidth (GBW) point where the gain becomes zero (which in turns increases stability and robustness at low loads), the output resistance of the first amplification stage has to be as high as possible for stability. This, however, results in a low bias current in the first stage which causes worse load transient performance. Therefore, the LDO regulator further includes a gain limitation circuit of the first amplification stage, for regulating the output resistance of the first amplification stage and consequently the gain of the first amplification stage depending on the load conditions of the linear regulator. The gain limitation circuit is implemented as a voltage-to-current feedback circuit (also called a series shunt feedback) coupled with the driver stage and the output of the first amplification stage. The gain limitation circuit includes a transistor that is driven by the drive voltage of the driver stage. Such a transistor is coupled between the first amplification stage and the intermediate amplification stage to provide current to the output node of the first amplification stage. The current supplied to the output node of the first amplification stage is controlled depending on the load conditions of the linear regulator, thereby regulating the output resistance of the first amplification stage. The gain limitation circuit further includes a current limitation circuit to limit the current provided to the output node of the first amplification stage and thereby limiting the regulation of the output resistance of the first amplification stage to low load conditions of the linear regulator. The current limitation circuit includes a current-limiting transistor having the source coupled with the supply voltage and the drain coupled with the source of the gain-limiting transistor. The gate of the current-limiting transistor is coupled with a constant voltage so that the current flowing therethrough is limited to a maximum current. At high load conditions, the current-limiting transistor limits the current of the gain limitation circuit as it enters the saturation region and the output resistance of the first amplification stage is no more reduced. Alternatively, the current limitation circuit may comprise a current mirror, one branch thereof having a transistor in diode configuration and a current source. The other branch of the current mirror has a transistor similar to the current-limiting transistor, whose gate is coupled with the gate and drain of the diode configured transistor.

However, such known solutions may turn out to be unsatisfactory in certain applications. In particular, the solution disclosed by U.S. Pat. No. 10,001,795 B2 does not allow to set independently the entry/exit points and the gain of the gain limiter circuit. Therefore, there is a need in the art to provide improved Miller-compensated LDO voltage regulators, e.g., having reduced area occupation, increased robustness and/or increased design flexibility.

### SUMMARY

One or more embodiments of the present disclosure contribute in providing improved LDO voltage regulators.

One or more embodiments relate to a voltage regulator circuit.

According to an aspect of the present description, a voltage regulator circuit includes an input supply terminal configured to receive an input supply voltage and a regulated output terminal configured to produce a regulated output voltage. A first amplification stage has a first input terminal coupled to a reference node to receive a first reference voltage and a second input terminal coupled to the regulated output terminal to receive the regulated output voltage. The first amplification stage is configured to produce an error signal at an intermediate node. An intermediate amplification stage has an input terminal coupled to the intermediate node to receive the error signal and an output terminal configured to produce an amplified error signal at a further intermediate node. A driver stage is configured to receive the amplified error signal and to produce a drive signal as a function thereof. A pass device has a conductive channel arranged between the input supply terminal and the regulated output terminal. The conductance of the pass device is controlled by the drive signal to produce the regulated output voltage. A compensation capacitance is coupled between the regulated output terminal and the intermediate node. A feedback circuit is configured to: compare the drive signal to a second reference voltage, produce a feedback current as a function of a difference between the drive signal and the second reference voltage, and source the feedback current to the intermediate node. The gain of the first amplification stage is thus limited as a function of the drive signal.

One or more embodiments may thus provide a Miller-compensated LDO regulator with improved phase margin at low loads, with reduced size of the Miller capacitance, where the entry/exit setpoint of the local feedback loop is deterministic, where the stability of the fast compensation loop is not affected, and which is robust due to the use of an active feedback loop.

### BRIEF DESCRIPTION OF THE DRAWINGS

One or more embodiments will now be described, by way of example, with reference to the annexed figures, wherein:

FIG. 1 is a circuit block diagram exemplary of the architecture of a Miller-compensated LDO voltage regulator;

FIG. 2 is a circuit diagram exemplary of possible implementation details of the MC-LDO regulator of FIG. 1;

FIG. 3 is a diagram that shows the phase margin of the transfer function of the LDO regulator of FIG. 1 as a function of the load current, for two different values of the Miller capacitance;

FIG. 4 is a circuit block diagram exemplary of the architecture of a Miller-compensated LDO voltage regulator according to one or more embodiments of the present description;

FIG. 5 is a circuit diagram exemplary of possible implementation details of the MC-LDO regulator of FIG. 4;

FIG. 6 is a diagram that shows a comparison between the phase margin of the transfer function of the LDO regulator of FIG. 1 and the phase margin of the transfer function of the LDO regulator of FIG. 4, as a function of the load current, for a first value of the Miller capacitance;

FIG. 7 is a diagram that shows the same comparison of FIG. 6 for a second value of the Miller capacitance; and

FIG. 8 is a diagram that shows the dependence of some electrical quantities in the LDO regulator of FIG. 4 on the load current.

### DETAILED DESCRIPTION

In the ensuing description, one or more specific details are illustrated, aimed at providing an in-depth understanding of examples of embodiments of this description. The embodiments may be obtained without one or more of the specific details, or with other methods, components, materials, etc. In other cases, known structures, materials, or operations are not illustrated or described in detail so that certain aspects of embodiments will not be obscured.

Reference to “an embodiment” or “one embodiment” in the framework of the present description is intended to indicate that a particular configuration, structure, or characteristic described in relation to the embodiment is included in at least one embodiment. Hence, phrases such as “in an embodiment” or “in one embodiment” that may be present in one or more points of the present description do not necessarily refer to one and the same embodiment. Moreover, particular configurations, structures, or characteristics may be combined in any adequate way in one or more embodiments.

The headings/references used herein are provided merely for convenience and hence do not define the extent of protection or the scope of the embodiments.

Throughout the figures annexed herein, unless the context indicates otherwise, like parts or elements are indicated with like references/numerals and a corresponding description will not be repeated for the sake of brevity.

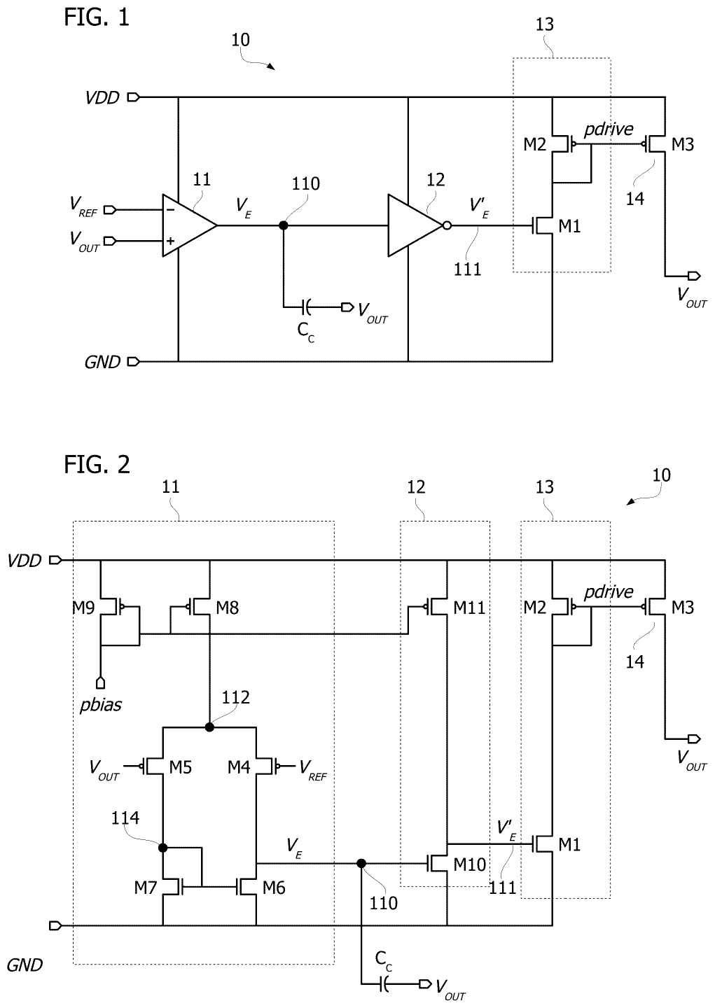

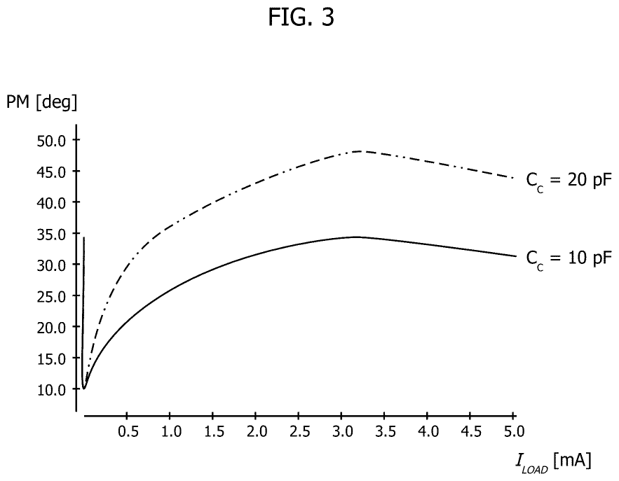

By way of introduction to the detailed description of exemplary embodiments, reference can be made to FIGS. 1, 2 and 3. FIG. 1 is a circuit block diagram exemplary of the architecture of a Miller-compensated LDO voltage regulator 10. FIG. 2 is a circuit diagram exemplary of possible implementation details of the LDO regulator 10. FIG. 3 is a diagram that shows the phase margin (PM, expressed in degrees) of the transfer function of the LDO regulator 10 as a function of the load current ILOAD (expressed in mA), for two different values of the Miller capacitance Cc, namely Cc=10 pF and Cc=20 pF.

As exemplified in FIGS. 1 and 2, the LDO regulator 10 includes a first amplification stage 11, an intermediate amplification stage 12, a driver stage 13, and a pass device 14. The first amplification stage 11 is a differential amplifier having a first (e.g., inverting) input terminal coupled to a reference node to receive a reference voltage V_{REF} and a second (e.g., non-inverting) input terminal coupled to the regulator output node to receive the regulator output voltage V_{OUT}. Thus, stage 11 acts as an error amplifier and produces at node 110 an error signal V_{E} as a function of (e.g., proportional to) the difference between voltages V_{OUT} and V_{REF}. The second input terminal of stage 11 may be coupled to the regulator output node via a (e.g., resistive) voltage divider, not visible in FIGS. 1 and 2. The first amplification stage 11 is biased between the input supply node of the regulator, which receives an input supply voltage VDD, and a ground node GND. The intermediate amplification stage 12 is coupled to the output of stage 11 (i.e., node 110) to receive the error signal V_{E} and produce an amplified error signal V′E at node 111. As exemplified in FIGS. 1 and 2, the intermediate amplification stage 12 may include an inverter circuit, biased between the input supply node of the regulator and the ground node GND. The driver stage 13 comprises a common source NMOS transistor M1 and a diode-connected driver PMOS transistor M2. In particular, transistors M1 and M2 are arranged so to have their conductive channels in series between the input supply node of the regulator and the ground node GND. Transistor M1 has a source terminal coupled to ground GND, a drain terminal coupled to the drain terminal of transistor M2, and a gate terminal coupled to node 111 to receive the amplified error signal V′E. Transistor M2 has a source terminal coupled to VDD, a drain terminal coupled to the drain terminal of transistor M1, and a gate terminal coupled to its drain terminal. Further, the gate terminal of the driver transistor M2 is connected to the control (e.g., gate) terminal of the pass device 14, which is also a PMOS transistor M3, to provide thereto a drive voltage pdrive. Transistors M2 and M3 thus form a current mirror, which mirrors the current flowing through M1 and M2 into transistor M3. The pass device 14 controls the conductance between the input node and the output node of the LDO regulator 10. In particular, transistor M3 has a source terminal coupled to the input supply node VDD, a drain terminal coupled to the output node of the LDO regulator 10 to produce the regulated output voltage V_{OUT}, and a gate terminal coupled to the gate terminal of transistor M2. A Miller compensation capacitance Cc is coupled between the output node of the regulator 10 and node 110 between the first amplification stage 11 and the intermediate amplification stage 12. A load may be coupled to the output node of the regulator, in parallel with an output capacitance (both the load and the output capacitance not being visible in FIGS. 1 and 2). The load sinks a load current ILOAD from the regulator 10.

FIG. 2 shows some possible implementation details of the first amplification stage 11 and the intermediate amplification stage 12.

As exemplified in FIG. 2, the first amplification stage 11 may include a (PMOS) input differential pair (M4, M5) biased by a (PMOS) tail current generator (M8) and loaded by a (NMOS) current mirror (M6, M7). In particular, a PMOS transistor M4 has a conductive channel arranged between a biasing node 112 (source terminal of M4) and node 110 (drain terminal of M4), and has a gate terminal that receives the reference voltage V_{REF}. A PMOS transistor M5 has a conductive channel arranged between node 112 (source terminal of M5) and a further node 114 (drain terminal of M4), and has a gate terminal that receives the regulator output voltage V_{OUT} (e.g., directly or via a voltage divider). An NMOS transistor M6 has a conductive channel arranged between node 110 (drain terminal of M6) and ground GND (source terminal of M6). A diode-connected NMOS transistor M7 has a conductive channel arranged between node 114 (drain terminal of M7) and ground GND (source terminal of M7). The gate terminals of transistors M6 and M7 are connected one to the other so that transistors M6 and M7 form a current mirror. In this way, the current flowing through transistor M7 is mirrored and sunk from node 110 by transistor M6, and node 110 is charged and discharged as a function of the difference between voltages V_{OUT} and V_{REF}. Further, a tail current generator is arranged between the biasing node 112 and the input supply node VDD to bias the input differential pair M4, M5. In particular, the tail current generator may be implemented as a PMOS current mirror that includes a PMOS transistor M8 and a diode-connected PMOS transistor M9. Transistor M8 has a conductive channel arranged between the input supply node VDD (source terminal of M8) and the biasing node 112 (drain terminal of M6). Transistor M9 has a conductive channel arranged between the input supply node VDD (source terminal of M9) and a biasing node that provides a fixed biasing voltage pbias (drain terminal of M9). The gate terminals of transistors M8 and M9 are connected one to the other so that M8 and M9 form a current mirror. In this way, the current flowing through transistor M9 is mirrored and sourced to node 112 by transistor M8.

As exemplified in FIG. 2, the intermediate amplification stage 12 may include a common source amplifier. In particular, stage 12 may include an NMOS transistor M10 arranged in a common source configuration, that is, having a conductive channel arranged between node 111 (drain terminal of M10) and ground GND (source terminal of M10), and a gate terminal coupled to node 110 to receive the error signal V_{E}. The common source transistor M10 may be biased by a PMOS transistor M11 having a conductive channel arranged between the input supply node VDD (source terminal of M11) and node 111 (drain terminal of M11), and a gate terminal coupled to the gate terminal of transistor M9. Thus, transistors M9 and M11 also form a current mirror.

FIG. 3 shows the phase margin PM of the transfer function of the LDO regulator 10 as a function of the load current ILOAD for two different values of the Miller capacitance, namely Cc=10 pF (solid line) and Cc=20 pF (dash-and-dot line). It can be seen that the Miller compensation is not effective at low loads (low values of ILOAD), insofar as the phase margin can get as small as about 10 degrees. Improving the phase margin (e.g., achieving a safe margin of about 30 degrees) would imply increasing the capacitance of the Miller capacitance Cc, with annexed drawbacks such as increased area occupation and increased instability of the fast LDO control loop.

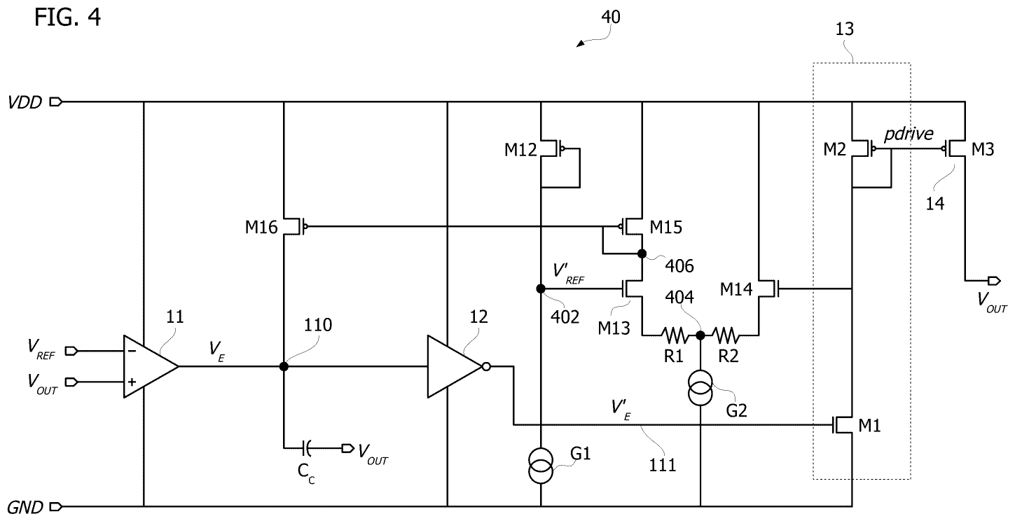

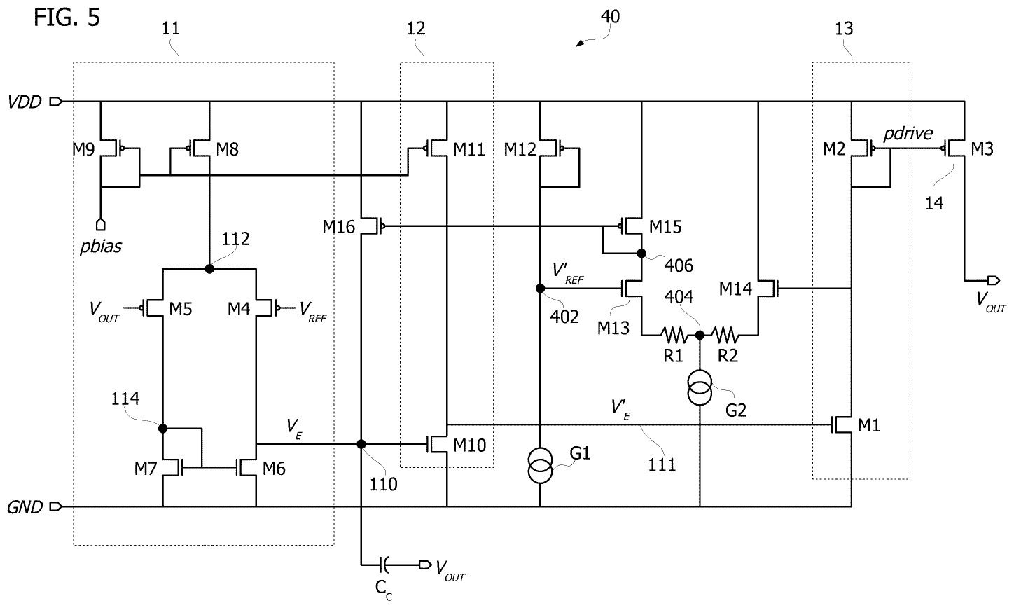

In view of the foregoing, one or more embodiments relate to a Miller-compensated LDO voltage regulator having an architecture that provides active pole splitting, that is, moves the frequency of the non-dominant pole of the overall transfer function to higher frequencies, thereby improving the LDO stability without the need of increasing the Miller capacitance Cc. Such improved architecture is exemplified in FIGS. 4 and 5, where parts and elements similar or identical to those of FIGS. 1 and 2 are indicated by similar or identical reference numbers, and a corresponding description is not repeated herein for the sake of brevity.

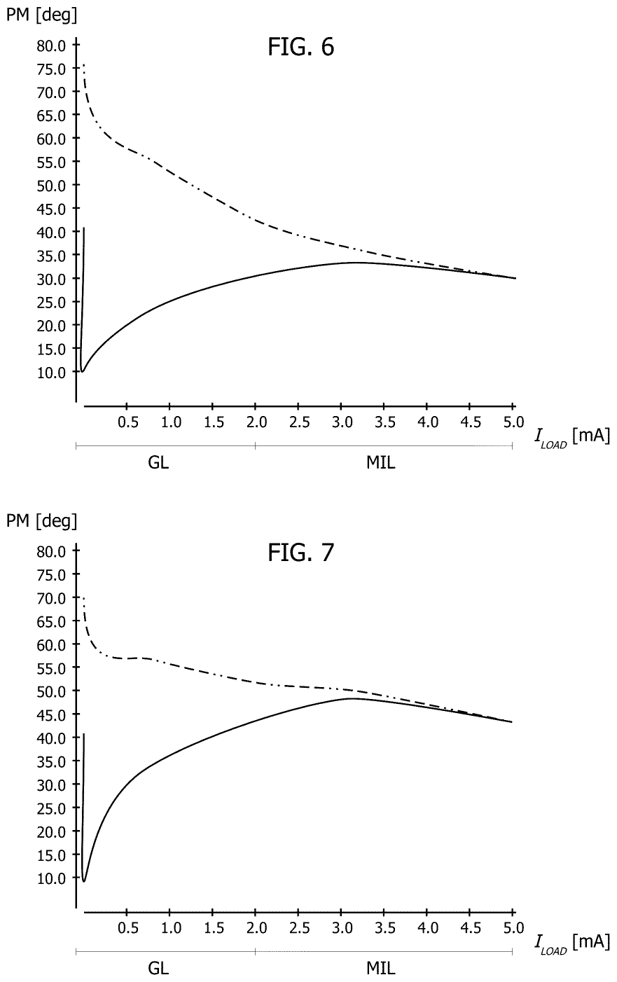

FIG. 4 is a circuit block diagram exemplary of the architecture of a Miller-compensated LDO voltage regulator 40 according to one or more embodiments. FIG. 5 is a circuit diagram exemplary of possible implementation details of the LDO regulator 40. FIG. 6 is a diagram that shows the comparison between the phase margin (PM) of the transfer function of the LDO regulator 40 (dash-and-dot line) and the phase margin of the transfer function of an LDO regulator according to the prior art (solid line) as a function of the load current ILOAD, for a Miller capacitance of 10 pF. FIG. 7 shows the same quantities of FIG. 6, in the case of a Miller capacitance of 20 pF.

Compared to the LDO regulator 10 of FIGS. 1 and 2, the LDO regulator 40 of FIGS. 4 and 5 further includes a local feedback circuit arranged between the driver stage 13 and node 110. The local feedback circuit is configured to reduce the impedance at node 110 (i.e., the high-impedance output node of the first amplification stage 11, where the Miller capacitance Cc is connected) by implementing an active feedback. Thus, the output resistance of the first amplification stage 11, and consequently the gain of the first amplification stage 11, are regulated by the local feedback loop depending on the load conditions of the regulator, which facilitates achieving high stability without increasing the capacitance of the Miller capacitor Cc. The local feedback loop operates mainly at low loads (i.e., low values of the load current ILOAD) while the Miller compensation loop operates mainly at high loads (i.e., high values of the load current ILOAD), and the transition between operation of the two loops takes place seamlessly at mid currents.

In particular, the local feedback loop is configured to compare the LDO drive voltage pdrive to a reference voltage V′REF, produce a feedback current as a function of the difference between the drive voltage pdrive and the reference voltage, and source such a feedback current to node 110 to limit the gain of the first amplification stage 11 as a function of the drive voltage pdrive. For instance, the relationship between the feedback current sourced to node 110 and the difference between pdrive and V′REF (i.e., pdrive-V′REF) may be linear (i.e., proportional).

As exemplified in FIGS. 4 and 5, the local feedback loop may thus include: a circuit arrangement (M12, G1) configured to produce the reference voltage; a low-transconductance differential pair (M13, M14) configured to compare the LDO drive voltage pdrive to the reference voltage (implementing active feedback to the input stage); and a current mirror (M15, M16) configured to mirror the current flowing through one branch of the differential pair into node 110.

In particular, in order to produce the reference voltage, a diode-connected PMOS transistor M12 and a current generator G1 are coupled in series between the input supply node VDD and ground GND. Transistor M12 has a source terminal coupled to node VDD, a drain terminal coupled to a first terminal of current generator G1 at node 402, and a gate terminal connected to its drain terminal. Current generator G1 has a first terminal coupled to node 402 and a second terminal coupled to ground GND, and is configured to sink a certain current (e.g., about 1 μA) from node 402. Thus, a reference voltage V′REF is produced at node 402.

Turning to the differential pair, an NMOS transistor M13 has a conductive channel arranged between a biasing node 404 (source terminal of M13, connected directly or via a resistance R1 to node 404) and a node 406 (drain terminal of M13), and has a gate terminal coupled to node 402 to receive the reference voltage V′REF. An NMOS transistor M14 has a conductive channel arranged between node 404 (source terminal of M14, connected directly or via a resistance R2 to node 404) and the input supply node VDD (drain terminal of M14), and has a gate terminal connected to the control (e.g., gate) terminal of the pass device 14 to receive the regulator drive voltage pdrive. A current generator G2 has a first terminal coupled to node 404 and a second terminal coupled to ground GND, and is configured to sink a certain current (e.g., about 50 nA) from node 404.

Additionally, a PMOS current mirror is coupled between node 406 and node 110 to mirror the feedback current that flows through transistor M13 and source such a feedback current to node 110, thereby regulating the impedance of node 110. In particular, a diode-connected PMOS transistor M15 has a conductive channel arranged between node 406 (drain terminal of M15) and the input supply node VDD (source terminal of M14). A PMOS transistor M16 has a conductive channel arranged between node 110 (drain terminal of M6) and the input supply node VDD (source terminal of M16). The gate terminals of transistors M15 and M16 are connected one to the other so that M15 and M16 form a current mirror. In this way, the current flowing through transistor M15 is mirrored and sourced to node 110 by transistor M16, and node 110 is charged and discharged as a function of the difference between voltages pdrive and V′REF.

Thanks to the architecture exemplifies in FIGS. 4 and 5, the differential stage that includes transistors M13 and M14 defines the amount of current to be injected into the output node 110 of the first amplification stage 11 as a function of the drive voltage pdrive, thus limiting the gain of the first amplification stage 11. The biasing generator G2 of the differential stage M13-M14 defines (e.g., limits) the amount of feedback current (e.g., 50 nA), and the reference voltage V′REF defines the entry/exit point of the gain limiter (i.e., the cut-off at which the gain limiter stops working, when the load current increases) or, in other words, defines the range of operation of the local feedback loop for low loads. As a result, the phase margin PM at low values of the load current ILOAD (e.g., up to about 2 mA) increases significantly compared to the LDO regulator 10 of FIGS. 1 and 2, while it remains similar to the one of LDO regulator 10 for medium and high values of the load current ILOAD (e.g., above about 2 mA) where the it is mainly the Miller compensation loop to determine the behavior of the LDO regulator.

FIG. 6 shows a comparison of the phase margin PM versus load current ILOAD for the LDO regulator 10 without gain limiter (solid line) and the LDO regulator 40 with gain limiter (dash-and-dot line) in an example where the Miller capacitance Cc is equal to about 10 pF. FIG. 7 shows the same comparison for a Miller capacitance Cc of about 20 pF. Substantially, in the region GL of low load current (e.g., ILOAD equal to about 0.1 mA, or ILOAD up to about 1-2 mA) the dominant pole is the output pole, having a frequency fpole=1/(2π·ROUT·COUT), and the pole due to the internal high-impedance node 110 is pushed to higher frequency by operation of the local feedback loop. In the region MIL of higher load current (e.g., ILOAD in the range of about 1-2 mA to 5 mA) the effect of the gain limiter fades out and the effect of the Miller compensation loop kicks in, insofar as the differential gain limiter stage M13-M14 is not able to provide AC feedback current to the high-impedance node 110. The dominant pole of the LDO transfer function is the internal one, due to node 110, and the output pole at frequency fpole=1/(2π·ROUT·COUT) is the non-dominant one. Effect of the local feedback loop can be seen in FIGS. 6 and 7, where it is shown that:
for Cc=10 pF (FIG. 6), an LDO regulator without gain limiter (as per FIGS. 1 and 2) has a minimum phase margin of about 10 degrees, while an LDO regulator with gain limiter (as per FIGS. 4 and 5) has a minimum phase margin of about 35 degrees; and
for Cc=20 pF (FIG. 7), an LDO regulator without gain limiter has a minimum phase margin of about 10 degrees, while an LDO regulator with gain limiter has a minimum phase margin of about 45 degrees.

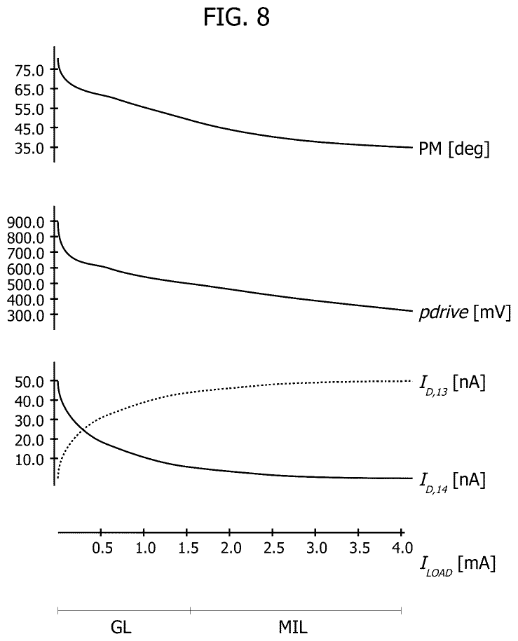

FIG. 8 is a further diagram that exemplifies the dependence of some electrical quantities in the LDO regulator 40 of FIGS. 4 and 5 with respect to the load current ILOAD, in a case where Cc=10 pF. The electrical quantities are: the phase margin PM of the LDO regulator, the drive voltage pdrive of the pass element 14, and the drain currents I_{D,13} and I_{D,14} of transistors M13 and M14 of the differential stage.

Therefore, one or more embodiments provide a Miller-compensated LDO regulator with improved phase margin at low loads (e.g., a minimum phase margin higher than 30 degrees), with reduced size of the Miller capacitance compared to other known solutions, where the entry/exit setpoint of the local feedback loop is deterministic (insofar as it can be set by selecting the value of the reference voltage V′REF), where the stability of the fast compensation loop is not affected (insofar as the Miller capacitance is kept small), and which is robust due to the use of an active feedback loop.

Without prejudice to the underlying principles, the details and embodiments may vary, even significantly, with respect to what has been described by way of example, without departing from the extent of protection.

The claims are an integral part of the technical teaching provided herein in respect of the embodiments.

The extent of protection is determined by the annexed claims.

1. A linear voltage regulator, comprising:
an input supply terminal configured to receive an input supply voltage;
a regulated output terminal configured to produce a regulated output voltage;
a first amplification stage having a first input terminal coupled to a reference node to receive a first reference voltage and a second input terminal coupled to said regulated output terminal to receive said regulated output voltage, wherein the first amplification stage is configured to produce an error signal at an intermediate node;
an intermediate amplification stage having an input terminal coupled to said intermediate node to receive said error signal and an output terminal configured to produce an amplified error signal at a further intermediate node;
a driver stage configured to receive said amplified error signal and produce a drive signal as a function thereof;
a pass device having a conductive channel arranged between said input supply terminal and said regulated output terminal, wherein a conductance of said pass device is controlled by said drive signal to produce said regulated output voltage;
a compensation capacitance coupled between said regulated output terminal and said intermediate node;
a feedback circuit including a comparison circuit configured to compare said drive signal to a second reference voltage and produce a feedback current as a function of a difference between said drive signal and said second reference voltage;
wherein said feedback current is sourced to said intermediate node to limit a gain of said first amplification stage.

2. The linear voltage regulator of claim 1, wherein said feedback circuit further includes a circuit arrangement configured to produce said second reference voltage, said circuit arrangement comprising:
a diode-connected transistor and a first current generator coupled in series between said input supply terminal and a ground terminal, wherein said second reference voltage is produced at a node intermediate therebetween.

3. The linear voltage regulator of claim 1, wherein said comparison circuit comprises a differential transistor pair including a first transistor having a control terminal configured to receive said second reference voltage, and a second transistor having a control terminal configured to receive said drive signal.

4. The linear voltage regulator of claim 3, wherein said comparison circuit further comprises a second current generator configured to bias said differential transistor pair.

5. The linear voltage regulator of claim 3, wherein said feedback circuit further includes a current mirror circuit comprising:
a diode-connected transistor having a conductive channel coupled in series to a conductive channel of the first transistor of the differential transistor pair; and
a mirroring transistor having a conductive channel coupled between said input supply terminal and said intermediate node, and having a control terminal connected to a control terminal of said diode-connected transistor.

6. The linear voltage regulator of claim 1, wherein said first amplification stage comprises:
an input differential pair of transistors configured to receive said first reference voltage and said regulated output voltage;
a biasing current mirror of transistors coupled to a biasing node of the input differential pair; and
a load current mirror of transistors coupled to said input differential pair.

7. The linear voltage regulator of claim 1, wherein said intermediate amplification stage comprises an inverter circuit.

8. The linear voltage regulator of claim 1, wherein said intermediate amplification stage comprises a common source amplifier including a common source MOS transistor having a gate terminal configured to receive said error signal, and
a further MOS transistor coupled in series with the common source MOS transistor;
wherein the said amplified error signal is produced at node intermediate therebetween.

9. The linear voltage regulator of claim 1, wherein said driver stage comprises a common source stage including:
a common source MOS transistor having a gate terminal configured to receive said amplified error signal; and
a diode-connected driver MOS transistor having a gate terminal configured to produce said drive signal;
wherein the common source MOS transistor and the diode-connected driver MOS transistor are coupled in series.

10. The linear voltage regulator of claim 1, wherein said pass device comprises a MOS transistor having a gate terminal configured to receive said drive signal.

11. A method, comprising:
generating an error signal at an intermediate node as a function of a difference between a first reference voltage and a regulator output voltage;
amplifying the error signal to generate an amplified error signal;
generating an output drive signal from the amplified error signal;
controlling an output MOS transistor with the output drive signal to generate the regulator output voltage;
comparing the output drive signal to a second reference voltage to generate a feedback current; and
applying the feedback current to the intermediate node.

12. The method of claim 11, further comprising applying a Miller compensation capacitance between the regulator output voltage and the intermediate node.

13. The method of claim 11, further comprising generating the second reference voltage by applying a first current through a diode-connected MOS transistor.

14. The method of claim 13, further comprising biasing an amplifier configured to generate the amplified error signal with a second current.

15. The method of claim 14, wherein the first current is larger than the second current.
